(19) United States
(12) Patent Application Publication
(10) Pub. No.: US 2025/0041144 A1
(43) Pub. Date: Feb. 6, 2025

(54) INTELLIGENT VIBRATION EQUIPMENT WITH LIFTING FUNCTION

(71) Applicant: Guangdong Nuojiang Health Technology Co., Ltd., Dongguan (CN)

(72) Inventors: Shengju ZHENG, Dongguan (CN); Lang DUAN, Dongguan (CN); Tao ZHANG, Dongguan (CN)

(73) Assignee: Guangdong Nuojiang Health Technology Co., Ltd., Dongguan (CN)

(21) Appl. No.: 18/370,083

(22) Filed: Sep. 19, 2023

(30) Foreign Application Priority Data
Aug. 2, 2023 (CN) 202322061153.4

(51) Int. Cl. A61H 1/00; A61H 23/02

(52) U.S. Cl. CPC A61H 1/005; A61H 23/0263; A61H 2201/0142; A61H 2201/0192; A61H 2201/149; A61H 2201/1669

(57) ABSTRACT

The invention discloses a vibration equipment with lifting function, comprising a foundation, a frame defined on the foundation, a driving member defined on the foundation or the frame, an elevating portion; one end of the elevating portion is rotatably connected on the frame and provided with a lifting assembly, one end of the lifting assembly is connected with the frame, another end with the elevating portion; the lifting assembly is used to drive the elevating portion to rotate relative to the frame, the foundation is equipped with a transmission mechanism, the frame is movably arranged on the foundation via the transmission mechanism; the transmission mechanism includes a link member, and the driving member includes an eccentric shaft, the driving member drives the eccentric shaft to rotate, the rotating eccentric shaft drives the frame to move back and forth relative to the foundation via the link member.

### CROSS-REFERENCE TO RELATED APPLICATIONS

This application claims the benefit of Chinese Application 202322061153.4 for an intelligent vibration equipment with lifting function (filed Aug. 2, 2023 at the China National Intellectual Property Administration, CNIPA). The entire contents of above applications are hereby incorporated by reference in their entirety.

### TECHNICAL FIELD

The invention pertains to the field of vibration equipment, particularly to an intelligent vibration equipment with lifting function.

### BACKGROUND

Currently, fitness beds in the health industry market generally rely on vibrations or reciprocating movements generated by eccentric shaft rotation to passively move the user's body and achieve automatic conditioning of each organ of the body.

In the conventional fields, most fitness beds make users to move up and down by making the bed frame to vibrate. Due to the unreasonable design of the structure in the prior art, users can only lie flat on the vibration structure, and sometimes they need to lift their head or legs, resulting in an unsatisfactory user experience.

### SUMMARY

The purpose of the invention is to solve the problems in the prior art. The present invention provides a vibration equipment with two lifting assemblies, two elevating portions defined on both ends of the frame is able to rotate and elevate at different or same angles.

In accordance with an aspect of the embodiment, there is provided an intelligent vibration equipment, comprising a foundation, a frame, a driving member, the foundation is placed on a ground, the frame is defined on the foundation, the driving member is defined on the foundation or the frame; further comprising an elevating portion, one end of the elevating portion is rotatably connected on the frame, the elevating portion is provided with a lifting assembly, one end of the lifting assembly is connected with the frame, another end of the lifting assembly is connected with the elevating portion; wherein, the lifting assembly is used to drive the elevating portion to rotate relative to the frame, the foundation is equipped with a transmission mechanism, the frame is movably arranged on the foundation via the transmission mechanism; the transmission mechanism includes a link member, and the driving member includes an eccentric shaft, the driving member drives the eccentric shaft to rotate, the rotating eccentric shaft drives the frame to move back and forth relative to the foundation via the link member. Due to the lifting assembly, the elevating portion located on both ends of the frame is able to rotate to elevate, making it easy for users to lift and place their heads or legs, the user is not limited to lying flat on the vibration equipment, and the vibration equipment of the present invention has strong practicality.

Preferably, the vibration equipment according to the present invention further includes a supporting frame arranged on the foundation, one end of the elevating portion is rotatably arranged on the supporting frame, one end of the lifting assembly is rotatably arranged on the supporting frame, another end of the lifting assembly is arranged on the other end of the elevating portion or in the middle of the elevating portion, the lifting assembly drives the elevating portion to rotate resulting in the elevating portion being defined at an angle relative to the supporting frame. The lifting assembly drives the elevating portion to rotate and elevate to a certain angle relative to the supporting frame, in order to meet different needs of users and provide them with a relaxation comfort.

Preferably, the vibration equipment according to the present invention further includes a movable frame, two ends of the elevating portion are rotatably arranged with the supporting frame and the movable frame respectively, the movable frame is movably connected to the supporting frame at one end away from the elevating portion, the lifting assembly drives the elevating portion to rotate, resulting in the elevating portion being set at an angle relative to the supporting frame, and the elevating portion and the movable frame being set at another angle. Due to the movable frame, the two elevating portions located on both ends of the frame are able to rotate and elevate at different or same angles, in order to meet the actual needs of users, thus the present invention has strong practicality.

Preferably, the vibration equipment according to the present invention further includes a connecting rod, one end of the connecting rod rotates with a free end of the movable frame, another end of the connecting rod rotates with the supporting frame, one end of the movable frame away from the elevating portion is movably connected to the supporting frame via the connecting rod.

Preferably, there are two connecting rods, one end of the two connecting rods is rotatably arranged at two ends of the movable frame away from each other, another end of the two connecting rods is rotatably arranged at two ends of the supporting frame away from each other. Thanks to the two connecting rods, the movable frame is balanced to prevent it from overturning due to uneven force during vibration.

Preferably, the transmission mechanism further includes a rotating shaft, two ends of the rotating shaft are respectively rotatably arranged at two ends of the foundation away from each other, the link member is connected to the rotating shaft, the driving member drives the eccentric shaft to rotate, the rotating eccentric shaft drives the frame to move back and forth relative to the foundation via the link member.

Preferably, there are two rotating shafts, the two rotating shafts are rotatably arranged at both ends of the foundation respectively.

Preferably, the link member includes a first link, a first supporting plate, and a linkage assembly; the linkage assembly includes a second link and a second supporting plate, one end of the first link is mounted on the outer side of the eccentric shaft, another end of the first link is rotatably defined with one end of the first supporting plate, another end of the first supporting plate is fixedly installed in the middle of the rotating shaft, one end of the second link is fixedly installed with the rotating shaft, another end of the second link is rotatably defined with one end of the second supporting plate, another end of the second supporting plate is fixedly installed with the frame. Due to buffering of the first link and the second link, the supporting frame is prevented from rapidly rising or falling, ensuring the stability during the vibration process of the supporting frame and improving user experience.

Preferably, there are two linkage assemblies, the two linkage assemblies are installed at two ends of the rotating shaft.

Preferably, there are two link members, the two link members are positioned at both ends of the foundation respectively, the two first links are mounted on the outer side of the eccentric shaft. Thanks to two linkage assemblies, the supporting frame is balanced to prevent the linkage assemblies from overturning due to uneven force during vibration.

Compared with the prior art, the present invention has the following advantages and beneficial effects. Due to the lifting assembly, the elevating portion located on both ends of the frame is able to rotate to elevate, making it easy for users to lift and place their heads or legs, the user is not limited to lying flat on the vibration equipment, and the vibration equipment of the present invention has strong practicality. Due to buffering of the first link and the second link, the supporting frame is prevented from rapidly rising or falling, ensuring the stability during the vibration process of the supporting frame and improving user experience.

### BRIEF DESCRIPTION OF DRAWINGS

The present invention will become more fully understood from the detailed description given herein below and the accompanying drawings which are given by way of illustration only, and thus are not limitative of the present invention, and wherein:

FIG. 1 is a schematic view of the structure of an intelligent vibration equipment with lifting function according to the disclosure;

FIG. 2 is a schematic view of the supporting frame according to the disclosure;

FIG. 3 is a schematic view of the foundation according to the disclosure.

### DETAILED DESCRIPTION OF THE EMBODIMENTS

The invention will be further described below in details with reference to the figures and embodiments.

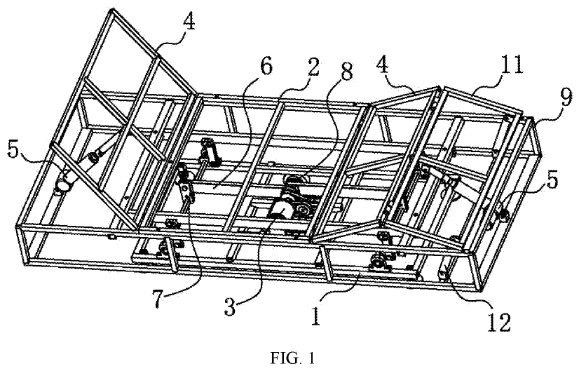

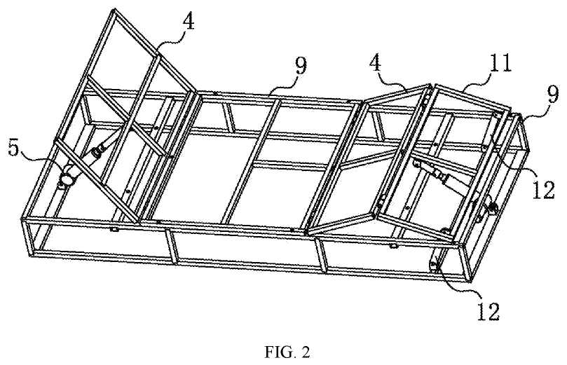

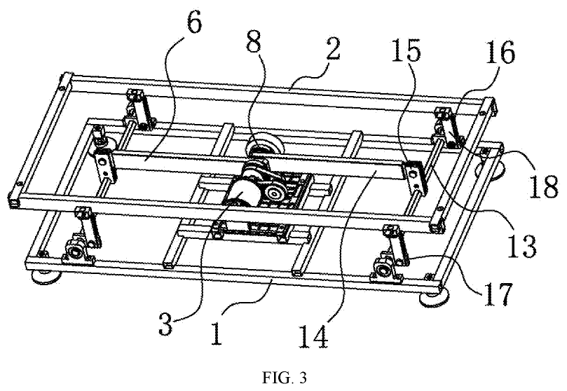

Please refer to FIG. 1 to FIG. 3, there is illustrated an intelligent vibration equipment with lifting function incorporating the principles of the present invention. The vibration equipment includes a foundation 1, a frame 2, a driving member 3, the foundation 1 is placed on a ground, the frame 2 is defined on the foundation 1, the driving member 3 is defined on the foundation 1 or the frame 2. The vibration equipment further comprise an elevating portion 4, one end of the elevating portion 4 is rotatably connected on the frame 2, the elevating portion 4 is provided with a lifting assembly 5, one end of the lifting assembly 5 is connected with the frame 2, another end of the lifting assembly 5 is connected with the elevating portion 4. The lifting assembly 5 is used to drive the elevating portion 4 to rotate relative to the frame 2, the foundation 1 is equipped with a transmission mechanism 6, the frame 2 is movably arranged on the foundation 1 via the transmission mechanism 6; the transmission mechanism 6 includes a link member 7, and the driving member 3 includes an eccentric shaft 8, the driving member 3 drives the eccentric shaft 8 to rotate, the rotating eccentric shaft 8 drives the frame 2 to move back and forth relative to the foundation 1 via the link member 7. The lifting assembly 5 enables the elevating portion 4 located at both ends of the frame 2 to rotate and elevate, making it convenient for users to lift and place their heads or legs. Users do not have to lie flat on the vibration equipment, thus the vibration equipment has strong practicality. Due to the lifting assembly 5, the elevating portion 4 defined on both ends of the frame 2 is able to rotate to elevate, making it easy for users to lift and place their heads or legs, the user is not limited to lying flat on the vibration equipment, and the vibration equipment of the present invention has strong practicality.

During use, the driving member 3 drives the eccentric shaft 8 to rotate, the rotating eccentric shaft 8 drives the frame 2 to move back and forth relative to the foundation1 via the link member 7, generating vibration and massaging the user. The lifting assembly 5 drives the elevating portion 4 to rotate and elevate to a certain angle relative to the supporting frame 9, in order to meet different needs of users and provide them with a relaxation comfort.

The vibration equipment according to the disclosure further includes a supporting frame 9 arranged on the foundation 1, one end of the elevating portion 4 is rotatably arranged on the supporting frame 9, one end of the lifting assembly 5 is rotatably arranged on the supporting frame 9, another end of the lifting assembly 5 is arranged on the other end of the elevating portion 4 or in the middle of the elevating portion 4, the lifting assembly 5 drives the elevating portion 4 to rotate resulting in the elevating portion 4 being defined at an angle relative to the supporting frame 9. The lifting assembly 5 drives the elevating portion 4 to rotate and elevate to a certain angle relative to the supporting frame 9, in order to meet different needs of users and provide them with a relaxation comfort.

The vibration equipment according to the disclosure further includes a movable frame 11, two ends of the elevating portion 4 are rotatably arranged with the supporting frame 9 and the movable frame 11 respectively, the movable frame 11 is movably connected to the supporting frame 9 at one end away from the elevating portion 4, the lifting assembly 5 drives the elevating portion 4 to rotate, resulting in the elevating portion 4 being set at an angle relative to the supporting frame 9, and the elevating portion 4 and the movable frame 11 being set at another angle. Due to the movable frame 11, the two elevating portions 4 located at both ends of the frame 2 are able to rotate and elevate at different or same angles, in order to meet the actual needs of users, thus the present invention has strong practicality.

The vibration equipment according to the disclosure further includes a connecting rod 12, one end of the connecting rod 12 rotates with a free end of the movable frame 11, another end of the connecting rod 12 rotates with the supporting frame 9, the end of the movable frame 11 away from the elevating portion 4 is movably connected to the supporting frame 9 via the connecting rod 12.

Preferably, there are two connecting rods 12, one end of the two connecting rods 12 is rotatably arranged at two ends of the movable frame 11 away from each other, another end of the two connecting rods 12 is rotatably arranged at two ends of the supporting frame 9 away from each other. Thanks to the two connecting rods 12, the movable frame 11 is balanced to prevent it from overturning due to uneven force during vibration.

The transmission mechanism 6 further includes a rotating shaft 13, two ends of the rotating shaft 13 are respectively rotatably arranged at two ends of the foundation 1 away from each other, the link member 7 is connected to the rotating shaft 13, the driving member 3 drives the eccentric shaft 13 to rotate, the rotating shaft 13 drives the frame 2 to move back and forth relative to the foundation via the link member 7.

Preferably, the rotating shaft 13 is a regular hexagonal prism. The rotating shaft 13 is installed with the first supporting plate 15 and the second link 17, the rotating shaft 13 of the regular hexagonal prism increases friction to prevent slipping.

Preferably, there are two rotating shafts 13, the two rotating shafts 13 are rotatably arranged at both ends of the foundation 1 respectively.

The link member 7 includes a first link 14, a first supporting plate 15, and a linkage assembly 16; the linkage assembly 16 includes a second link 17 and a second supporting plate 18, one end of the first link 14 is mounted on the outer side of the eccentric shaft 8, another end of the first link 14 is rotatably defined with one end of the first supporting plate 15, another end of the first supporting plate 15 is fixedly installed in the middle of the rotating shaft 13, one end of the second link 17 is is fixedly installed with the rotating shaft 13, another end of the second link 17 is rotatably defined with one end of the second supporting plate 18, another end of the second supporting plate 18 is fixedly installed with the frame 2. Due to buffering of the first link 14 and the second link 17, the supporting frame 9 is prevented from rapidly rising or falling, ensuring the stability during the vibration process of the supporting frame 9 and improving user experience.

Preferably, there are two linkage assemblies 16, the two linkage assemblies 16 are installed at two ends of the rotating shaft 13.

Preferably, there are two link members 7, the two link members 7 are positioned at both ends of the foundation 1 respectively, the two first links 14 are mounted on the outer side of the eccentric shaft 8. Thanks to two linkage assemblies 16, the supporting frame 9 is balanced to prevent the linkage assemblies 16 from overturning due to uneven force during vibration.

During use, the driving member 3 drives the eccentric shaft 13 to rotate, the rotating shaft 13 drives the first link 14, the first link 14 drives the first supporting plate 15, the first supporting plate 15 drives the rotating shaft 13 to rotate back and forth, the reciprocating shaft 13 drives the second link 17, the second link 17 drives the second supporting plate 18, the second supporting plate 18 is fixedly installed with the frame 2, the supporting frame 9 is fixedly installed with frame 2, the supporting frame 9 moves back and forth relative to the foundation 1, generating vibration and massaging the user. The lifting assembly 5 drives the elevating portion 4 to rotate and elevate to a certain angle relative to the supporting frame 9, resulting in the elevating portion 4 being set at an angle relative to the movable frame 11, in order to meet different needs of users and provide them with a relaxation comfort.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

What is claimed is:

1. An intelligent vibration equipment with lifting function, comprising:
a foundation, a frame, a driving member, the foundation is placed on a ground, the frame is defined on the foundation, the driving member is defined on the foundation or the frame; further comprising an elevating portion, one end of the elevating portion is rotatably connected on the frame, the elevating portion is provided with a lifting assembly, one end of the lifting assembly is connected with the frame, another end of the lifting assembly is connected with the elevating portion; wherein, the lifting assembly is used to drive the elevating portion to rotate relative to the frame, the foundation is equipped with a transmission mechanism, the frame is movably arranged on the foundation via the transmission mechanism; the transmission mechanism includes a link member, and the driving member includes an eccentric shaft, the driving member drives the eccentric shaft to rotate, the rotating eccentric shaft drives the frame to move back and forth relative to the foundation via the link member.

2. The vibration equipment of claim 1, wherein further includes a supporting frame arranged on the foundation, one end of the elevating portion is rotatably arranged on the supporting frame, one end of the lifting assembly is rotatably arranged on the supporting frame, another end of the lifting assembly is arranged on the other end of the elevating portion or in the middle of the elevating portion, the lifting assembly drives the elevating portion to rotate resulting in the elevating portion being defined at an angle relative to the supporting frame.

3. The vibration equipment of claim 2, wherein further includes a movable frame, two ends of the elevating portion are rotatably arranged with the supporting frame and the movable frame respectively, the movable frame is movably connected to the supporting frame at one end away from the elevating portion, the lifting assembly drives the elevating portion to rotate, resulting in the elevating portion being set at an angle relative to the supporting frame, and the elevating portion and the movable frame being set at another angle.

4. The vibration equipment of claim 3, wherein further includes a connecting rod, one end of the connecting rod rotates with a free end of the movable frame, another end of the connecting rod rotates with the supporting frame, one end of the movable frame away from the elevating portion is movably connected to the supporting frame via the connecting rod.

5. The vibration equipment of claim 4, wherein there are two connecting rods, one end of the two connecting rods is rotatably arranged at two ends of the movable frame away from each other, another end of the two connecting rods is rotatably arranged at two ends of the supporting frame away from each other.

6. The vibration equipment of claim 1, wherein the transmission mechanism further includes a rotating shaft, two ends of the rotating shaft are respectively rotatably arranged at two ends of the foundation away from each other, the link member is connected to the rotating shaft, the driving member drives the eccentric shaft to rotate, the rotating eccentric shaft drives the frame to move back and forth relative to the foundation via the link member.

7. The vibration equipment of claim 6, wherein there are two rotating shafts, the two rotating shafts are rotatably arranged at both ends of the foundation respectively.

8. The vibration equipment of claim 6, wherein the link member includes a first link, a first supporting plate, and a linkage assembly; the linkage assembly includes a second link and a second supporting plate, one end of the first link is mounted on the outer side of the eccentric shaft, another end of the first link is rotatably defined with one end of the first supporting plate, another end of the first supporting plate is fixedly installed in the middle of the rotating shaft, one end of the second link is fixedly installed with the rotating shaft, another end of the second link is rotatably defined with one end of the second supporting plate, another end of the second supporting plate is fixedly installed with the frame.

9. The vibration equipment of claim 8, wherein there are two linkage assemblies, the two linkage assemblies are installed at two ends of the rotating shaft.

10. The vibration equipment of claim 8, wherein there are two link members, the two link members are positioned at both ends of the foundation respectively, the two first links are mounted on the outer side of the eccentric shaft.
